(19) United States
(12) Patent Application Publication
(10) Pub. No.: US 2017/0158081 A1
(43) Pub. Date: Jun. 8, 2017

(54) BATTERY COOLING SYSTEM FOR A VEHICLE

(71) Applicant: Hyundai Motor Company, Seoul (KR)

(72) Inventors: Jae Yeon Kim, Hwaseong (KR); Myunghwan Kim, Hwaseong (KR); Jeong Yeop Woo, Incheon (KR); Yeon Ho Kim, Seoul (KR); Wan Je Cho, Hwaseong (KR); Gun Goo Lee, Suwon (KR)

(21) Appl. No.: 15/180,192

(22) Filed: Jun. 13, 2016

(30) Foreign Application Priority Data
Dec. 8, 2015 (KR) 10-2015-0174241

(51) Int. Cl. B60L 11/18; H01M 10/625; H01M 10/663; B60H 1/00; H01M 10/63; H01M 10/615; H01M 10/617; H01M 10/613; H01M 10/6568

(52) U.S. Cl. CPC B60L 11/1874; H01M 10/613; H01M 10/625; H01M 10/663; H01M 10/6568; H01M 10/63; H01M 10/615; H01M 10/617; B60H 1/00278; B60L 11/1875; H01M 2220/20

(57) ABSTRACT

A vehicle battery cooling system is provided and includes an air conditioning device including a compressor, condenser, evaporator, and first expansion valve connected via a refrigerant line and circulates refrigerant to reduce temperature within the vehicle. An electric unit cooling device includes an electric unit radiator and water pump connected with a cooling line and circulates cooling water to cool a motor and electric unit. A battery module connects with the cooling device via a battery cooling line. A chiller connects with the refrigerant line via a first connection line and the battery cooling line via a second connection line, and adjusts cooling water temperature by selectively heat-exchanging cooling water and refrigerant. Another water pump is disposed on the battery cooling line between the battery module and the chiller and a heater is disposed on the battery cooling line between the other water pump and the battery module.

### CROSS-REFERENCE TO RELATED APPLICATION

This application claims priority to and the benefit of Korean Patent Application No. 10-2015-0174241 filed in the Korean Intellectual Property Office on Dec. 8, 2015, the entire contents of which are incorporated herein by reference.

### BACKGROUND

(a) Field of the Invention

The present invention relates to a battery cooling system for a vehicle, and more particularly, to a battery cooling system for a vehicle, that interlocks an air conditioning device and an electric unit cooling device that circulates cooling water in a motor and an electric unit within an electric vehicle or a hybrid vehicle and warms up or cools down a battery module based on a vehicle state using the cooling water circulating the electric unit cooling device.

(b) Description of the Related Art

In general, an air conditioning system for a vehicle includes an air conditioning system that circulates a refrigerant to warm up or cool down the interior of the vehicle (e.g., increase or decrease the temperature within the vehicle). The air conditioning device is capable of maintaining a comfortable indoor environment of the vehicle by maintaining a vehicle indoor temperature at an appropriate temperature regardless of an exterior temperature change, and the refrigerant discharged by driving of a compressor circulates back to the compressor through a condenser, a receiver dryer, an expansion valve, and an evaporator and heat exchange occurs during the circulation to increase or decrease the temperature within the vehicle.

In other words, in a summer cooling mode, a high-temperature and high-pressure gaseous refrigerant compressed by the compressor is condensed through the condenser and then evaporated through the receiver dryer and the expansion valve to reduce the indoor temperature and humidity of the vehicle. Recently, there is a need of developing an environmentally-friendly vehicle capable of substantially replacing the Internal Combustion Engine (ICE) vehicles, with an increasing concern regarding energy efficiency and the problem with environmental pollution and the environmentally-friendly vehicle generally falls into an electric vehicle driven by a fuel cell or electricity, which is the power source, and a hybrid vehicle driven by an engine and an electric battery.

In the electric vehicle, among the environmentally-friendly vehicles, a separate heater is not used unlike an air conditioner of a general vehicle, and an air conditioner, which is applied to the electric vehicle, is typically referred to as a heat pump system. In the electric vehicle, chemical reaction energy of oxygen and hydrogen is converted into electric energy to generate driving force, and during this process, heat energy is generated by chemical reaction in the fuel cell, and as a result, effectively removing generated heat is required to secure performance of the fuel cell.

Even in the hybrid vehicle, the driving force is generated by driving the motor by using electricity supplied from the fuel cell or the electric battery together with the engine that is actuated with general fuel, and as a result, the performance of the motor may be secured only by effectively removing the heat generated from the fuel cell or the battery, and the motor. Accordingly, in a hybrid vehicle or an electric vehicle according to the related art requires an electric unit cooling device, a heat pump system, and a battery cooling system, respectively formed as closed circuits, to prevent overheat of a battery including a motor, an electric unit, and a fuel cell.

Thus, the size and weight of a cooling module provided in the front side of the vehicle increase, and a layout of connection pipe through which a refrigerant or cooling water is supplied to the heat pump system, the electric unit cooling device, and the battery cooling system respectively in an engine compartment becomes complex. Further, since the battery cooling system that warms up or cools down the battery based on a vehicle state for optimal performance of the battery is provided separately, a plurality of valves are required to connect the battery cooling system to the respective connection pipes and noise and vibration generated from frequent closing and opening of the valves are transferred to the interior of the vehicle, thereby deteriorating riding comfort.

The above information disclosed in this section is merely for enhancement of understanding of the background of the invention and therefore it may contain information that does not form the prior art that is already known in this country to a person of ordinary skill in the art.

### SUMMARY

The present invention provides a battery cooling system for a vehicle, which selectively uses a refrigerant and cooling water that circulate through an air conditioning device and an electric unit cooling device within an electric vehicle or a hybrid vehicle to warm up or cool down a battery module in a water-cooling manner to increase a total travel distance of the vehicle through effective battery management.

A battery cooling system for a vehicle according to an exemplary embodiment of the present invention may include: an air conditioning device including a compressor, a condenser, an evaporator, and a first expansion valve connected via a refrigerant line and configured to circulate a refrigerant to cool the interior of the vehicle; an electric unit cooling device including an electric unit radiator and a first water pump connected with a refrigerant line and configured to circulate cooling water to cool a motor and an electric unit; a battery module connected with the electric unit cooling device via a battery cooling line; a chiller connected with the refrigerant line of the air conditioning device via a first connection line, connected with the battery cooling line via a second connection line, and configured to adjust a temperature of the cooling water by selectively heat-exchanging the cooling water and the refrigerant introduced thereinto; a second water pump disposed on the battery cooling line between the battery module and the chiller; and a heater disposed on the battery cooling line between the second water pump and the battery module.

The first connection line may include a second expansion valve disposed between the condenser and the chiller. The second expansion valve may be configured to operate when a vehicle cooling mode starts or to cool the battery module using the refrigerant, and may expand the refrigerant introduced through the first connection line and introduce the expanded refrigerant to the chiller.

The battery cooling line may include: a first valve that connects the cooling line that connects the motor and the electric unit and the battery cooling line between the electric unit radiator and the heater; and a second valve that connects the cooling line, the battery cooling line, and the second connection line connected with the chiller between the battery module and the electric unit radiator.

The first valve may connect the cooling line connected with the electric unit radiator, the cooling line connected with the motor and the electric unit, and the battery cooling line when cooling the battery module using cooling water. The second valve may be configured to close the second connection line when cooling the battery module using cooling water. The second valve may further be configured to close the cooling line and connect the battery cooling line and the second connection line when cooling the battery module using a refrigerant. The first valve and the second valve may be 3-way valves.

A reservoir tank may be disposed on the cooling line between the electric unit radiator and the first valve. The electric unit may include: an electric power control unit (EPCU) disposed on the cooling line between the motor and the first water pump; and an on-board charger (OBC) disposed on the cooling line between the motor and the electric unit radiator. The first water pump and the second water pump may be electrical water pumps. When warming up the battery module, the heater may be turned on to heat cooling water circulating in the battery cooling line and introduce the heated cooling water to the battery module.

As described above, the battery cooling system for the vehicle according to the exemplary embodiment of the present invention may selectively use a refrigerant and cooling water circulating in an air conditioning device and an electric unit cooling device within an electric vehicle or a hybrid vehicle to warm up or cool down a battery module in a water-cooling manner to simplify the system, and increase the total travel distance of the vehicle through effective battery management.

Further, through simplification of the entire system, manufacturing cost and weight may be reduced and spatial utilization may be improved. In addition, the number of valves for inter-working of the air conditioning device and the electric unit cooling device may be decreased to thereby reduce cost, and noise and vibration due to frequent valve opening and closing operations may be reduced to improve riding comfort of the vehicle

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram of a battery cooling system for a vehicle according to an exemplary embodiment of the present invention;

FIG. 2 is an operational state view illustrating cooling of a battery module during a vehicle cooling mode in the battery cooling system for the vehicle according to the exemplary embodiment of the present invention;

FIG. 3 is an operational state view illustrating cooling of the battery module using a refrigerant in the battery cooling system for the vehicle according to the exemplary embodiment of the present invention;

FIG. 4 is an operational state view illustrating cooling of the battery module during cooling of a motor and an electric unit in the battery cooling system for the vehicle according to the exemplary embodiment of the present invention;

FIG. 5 is an operational state view illustrating cooling of the battery module while cooling of the motor and the electric unit are stopped in the battery cooling system for the vehicle according to the exemplary embodiment of the present invention;

FIG. 6 is an operational state view illustrating warming up of the battery module when an air conditioning device and an electric unit cooling device do not operate in the battery cooling system for the vehicle according to the exemplary embodiment of the present invention.

### DESCRIPTION OF SYMBOLS

100: battery cooling system
110: air conditioning means
111: refrigerant line
112: compressor
113: condenser
114: first expansion valve
115: evaporator
116: second expansion valve
120: electric unit cooling means
121: cooling line
122: electric unit radiator
123: cooling fan
124: first water pump
125: motor
126: electric unit
129: reservoir tank
130: battery module
131: battery cooling line
132: first connection line
133: second connection line
135: chiller
137: second water pump
139: heater
140: first valve
150: second valve

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An exemplary embodiment of the present invention will hereinafter be described in detail with reference to the accompanying drawings. Therefore, configurations illustrated in the exemplary embodiments and the drawings described in the present specification are only exemplary embodiments of the present invention and do not represent all of the technical spirit of the present invention, and thus it is to be understood that various modified examples, which may replace the configurations, are possible when filing the present application.

Further, the size and thickness of each component illustrated in the drawings are arbitrarily shown for better understanding and ease of description, but the present invention is not limited thereto. Thicknesses are enlarged to clearly express various portions and areas. In addition, unless explicitly described to the contrary, “unit”, “means”, “part”, “member”, or the like, which is described in the specification, means a unit of a comprehensive configuration that performs at least one function or operation.

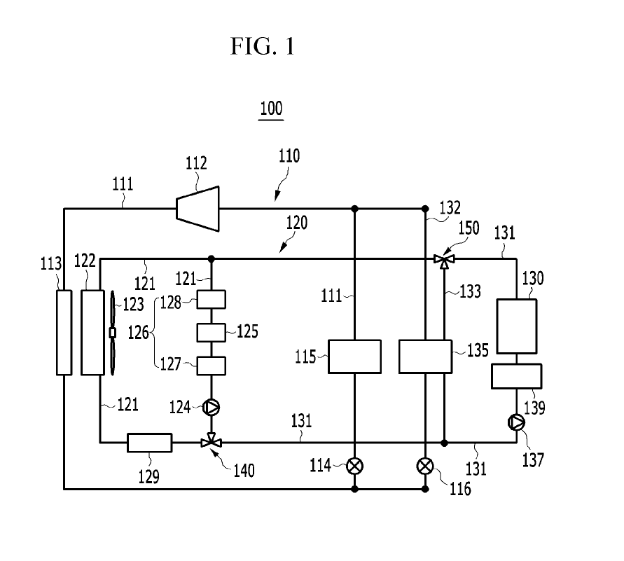

FIG. 1 is a block diagram of a battery cooling system for a vehicle according to an exemplary embodiment of the present invention. Referring to FIG. 1, a battery cooling system 100 for a vehicle according to the exemplary embodiment of the present invention is applicable to a hybrid vehicle or an electric vehicle, which also uses an engine and a motor together. The battery cooling system 100 interacts with an air conditioning device 110, which is an air conditioner configured to increase or decrease the temperature within the vehicle, and an electric unit cooling device 120 configured to cool down (e.g., decrease the temperature of) a motor 125 and an electric unit 126.

In the present exemplary embodiment, the air conditioning device 110 may include a compressor 112, a condenser 113, an evaporator 114, and a first expansion valve 115 that are connected with each other via a refrigerant line 111. The air conditioning device 110 may be configured to cool down (e.g., decrease the temperature of) the interior of the vehicle through circulation of a refrigerant during a vehicle cooling mode. The electric unit cooling device 120 may include an electric unit radiator 122 and a first water pump 124 connected via the cooling line 121, and configured to circulate cooling water to cool the motor 125 and the electric unit 126. Particularly, the electric unit 126 may include an electric power control unit (EPCU) 127 disposed on the cooling line 121 between the motor 125 and the first water pump 124 and an on-board charger (OBC) 128 disposed on the cooling line 121 between the motor 125 and the electric unit radiator 122.

The electric unit radiator 122 may be disposed in a front side of the vehicle, and a cooling fan 123 may be disposed in a rear side of the vehicle to cool cooling water by operation with the cooling fan 123 and heat exchange with an outside air. The electric unit cooling device 120 configured as above may be configured to circulate the cooling water cooled in the electric unit radiator 122 through the cooling line 121 by operation of the first water pump 124 to cool down the motor 125 and the electric unit 126. In particular, the battery cooling system 100 according to the exemplary embodiment of the present invention may include a battery module 130, a chiller 135, a second water pump 137, and a heater 139.

The battery module 130 may be configured to supply power to the motor 125 and the electric unit 126, and may be connected with the electric unit cooling device 120 via a battery cooling line 131. In particular, the battery module 130 may be a water-cooled type and thus may be cooled by cooling water. The chiller 135 may be connected with the refrigerant line 111 of the air conditioning device 110 via a first connection line 132, may be connected with the battery cooling line 131 via a second connection line 133, and may be configured to adjust a temperature of the cooling water by heat-exchanging cooling water and a refrigerant flowing therein.

Particularly, in the first connection line 132, a second expansion valve 116 may be disposed between the condenser 113 and the chiller 135. The second expansion valve 116 may be configured to operate when a vehicle cooling mode starts or the battery module 130 is cooled using the refrigerant. The second expansion valve 116 may expand the refrigerant introduced through the first connection line 132 to introduce the refrigerant in a lower temperature state to the chiller 135.

In other words, the second expansion valve 116 may expand the condensed refrigerant discharged from the condenser 113 to decrease the temperature of the refrigerant and introduce the low-temperature refrigerant to the chiller 135 to further decrease a temperature of the cooling water passing through the inside of the chiller 135. Accordingly, the cooling water of which the temperature is decreased while passing through the chiller 135 is may be into the battery module 130 to more efficiently cool down the battery module 130.

Additionally, the second water pump 137 may be disposed on the battery cooling line 131 between the battery module 130 and the chiller 135. The second water pump 137 may be configured to circulate the cooling water to the battery cooling line 131. Particularly, the first water pump 124 and the second water pump 135 may be electrical water pumps. The heater 139 may be disposed on the battery cooling line 131 between the second water pump 135 and the battery module 130. When the battery module 130 is warmed up, the heater 139 may be turned on to heat the cooling water circulating the battery cooling line 131 and introduce the heated cooling water.

In the present exemplary embodiment, the battery cooling line 130 may include a first valve 140 and a second valve 150. The first valve 140 may connect the cooling line 121 that connects the motor 125 and the electric unit 126 and the battery cooling line 131 between the electric unit radiator 122 and the heater 139. The first valve 140 may connect the electric unit radiator 122, the cooling line 121 connected to the motor 125 and the electric unit 126, and the battery cooling line 131 when cooling the battery module 130 using the cooling water.

In addition, the second valve 150 may connect the cooling line 121, the battery cooling line 131, and the second connection line 133 connected with the chiller 135 between the battery module 130 and the electric unit radiator 122. The second valve 150 may be configured to close the second connection line 133 connected with the chiller 135 when cooling down the battery module 130 using the cooling water. In addition, the second valve 150 may be configured to close the cooling line 121 and connect the battery cooling line 131 and the second connection line 133 when cooling down the battery module 130 using the refrigerant. The first valve 140 and the second valve 150 may be 3-Way valves.

Meanwhile, the cooling line 121 may include a reservoir tank 129 disposed between the electric unit radiator 122 and the first valve 140. The reservoir tank 129 may be configured to store cooled cooling water introduced from the electric unit radiator 122. In the present exemplary embodiment, the first water pump 124 may be disposed on the cooling line 121 between the first valve 140 and a power controller 127, but the present invention is not limited thereto. The first water pump 124 may be disposed on the cooling line 121 between the first valve 140 and the reservoir tank 129. When the first water pump 124 is disposed between the reservoir tank 129 and the first valve 140, the first water pump 124 may be configured to operate together with the second water pump 137 when cooling the battery module 130 with the cooling water to increase the flow amount of cooling water circulating the battery module 130.

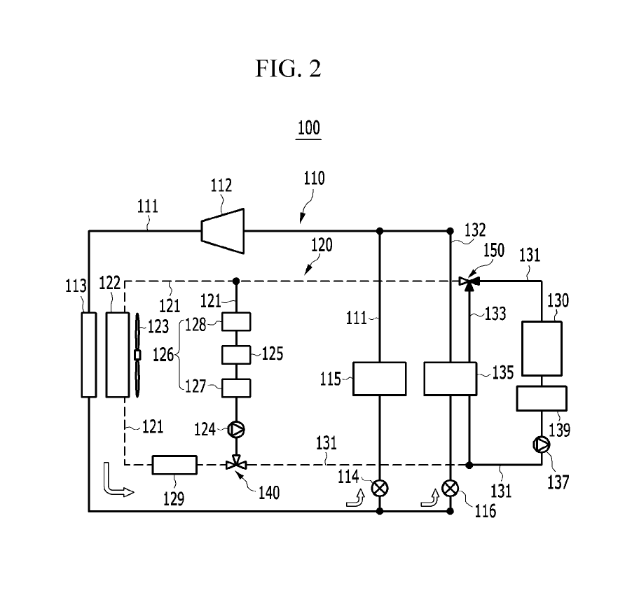

Hereinafter, operation of the battery cooling system 100 configured as above according to the exemplary embodiment of the present invention in cooling down and warming up of the battery module 130 will be described in detail. FIG. 2 is a state view illustrating cooling down of the battery during the vehicle cooling mode in the battery cooling system according to the exemplary embodiment of the present invention.

Referring to FIG. 2, when the battery module 130 may be cooled down during the vehicle cooling mode, the air conditioning device 110 may be configured to operate to circulate the refrigerant along the refrigerant line 111 and the interior of the vehicle may be cooled down accordingly (e.g., the interior temperature may be decreased). In particular, the refrigerant may be introduced to the condenser 113 from the compressor 112 and may be passed through the first expansion valve 114 along the cooling line 121 while being condensed through heat-exchange with the exterior air.

The refrigerant expanded while passing through the first expansion valve 114 may be evaporated through the evaporator 115, and then supplied again to the compressor 112 and may circulate in the air conditioning device 110. In particular, the second expansion valve 116 may be opened, and partially expand the refrigerant discharged from the condenser 113 and may be configured to supply the expanded refrigerant to the chiller 135. Further, the second valve 135 may be configured to close the cooling line 121, and connect the battery cooling line 131 and the second connection line 133. Then, the cooling water cooled from heat-exchange with the refrigerant in the chiller 135 may be introduced into the battery module 130 by operation of the second water pump 137. Accordingly, the cooled cooling water may be effectively cool down the battery module 130.

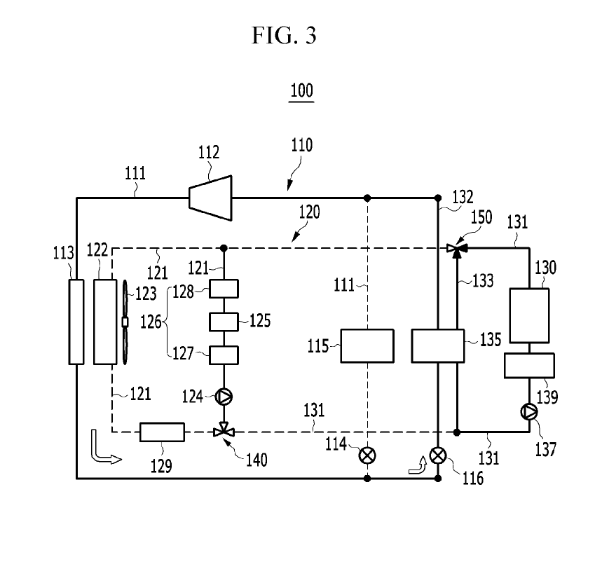

FIG. 3 is an operation view illustrating cooling down of the battery using the refrigerant in the battery cooling system according to the exemplary embodiment of the present invention. Referring to FIG. 3, when the battery module 130 may be cooled using the refrigerant, operation of the first expansion valve 114 of the air conditioning device 110 may be stopped to prevent further refrigerant from being introduced into the evaporator 115.

In the above-described state, the refrigerant may be introduced into the condenser 113 from the compressor 112 and condensed through heat-exchange with the exterior air. After that, the refrigerant may be discharged from the condenser 113 and expanded while passing through the second expansion valve 116 along the cooling line 121, and then passed through the chiller 135 and supplied back to the compressor 112. Particularly, the second valve 135 may be configured to close the cooling line 121 and connect the battery cooling line 131 and the second connection line 133. Then, the cooling water cooled through heat-exchange with the refrigerant in the chiller 135 may be introduced into the battery module 130 by operation of the second water pump 137. Accordingly, the cooled cooling water may effectively cool the battery module 130.

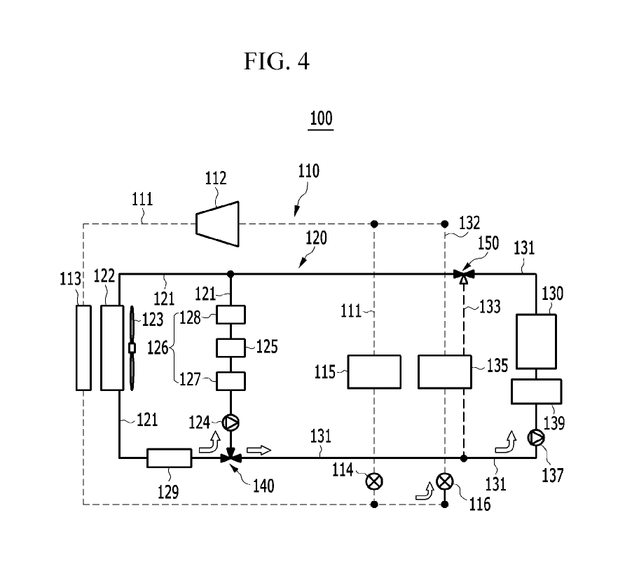

Meanwhile, in FIG. 2 and FIG. 3, the electric unit cooling device 120 does not operate in the exemplary embodiment of the present invention, but the present invention is not limited thereto, and the cooling water may be circulated through the cooling line 121 when the motor 125 and the electric unit 126 require cooling. FIG. 4 is an operational view illustrating cooling of the battery while cooling the motor and the electric unit in the battery cooling system for the vehicle according to the exemplary embodiment of the present invention.

Referring to FIG. 4, the electric unit cooling device 120 may be configured to operate to cool the motor 125 and the electric unit 126. Particularly, the first valve 140 may connect the electric unit radiator 122, the cooling line 121 connected to the motor 125 and the electric unit 126, and the battery cooling line 131. In addition, the second valve 150 may be configured to close the second connection line 133 connected with the chiller 135.

Accordingly, cooling water cooled in the electric unit radiator 113 may circulate in the cooling line 121 to cool the motor 125 and the electric unit 126 by operation of the first water pump 124. Simultaneously, the cooling water may circulate in the battery cooling line 131 by operation of the second water pump 137. Then, among the cooling water circulating the electric unit cooling device 120, cooling water cooled through the electric unit radiator 122 may be introduced into the battery cooling line 131 and thus may flow into the battery module 130 through the turned-off heater 139. Accordingly, the cooled cooling water may cool the battery module 130.

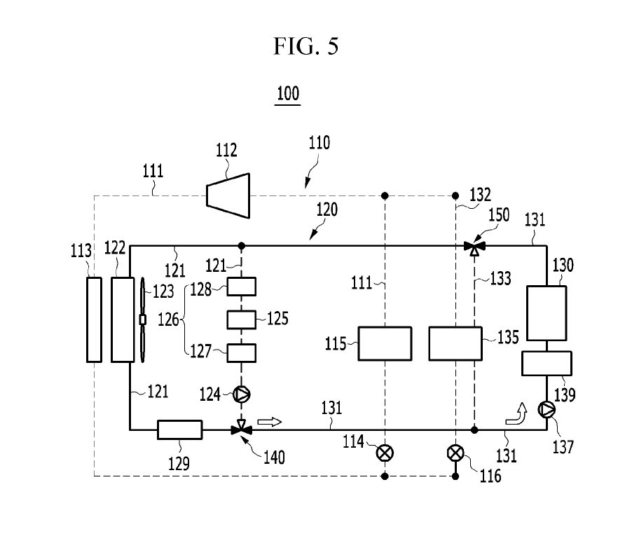

FIG. 5 is an operational view illustrating cooling of the battery while the motor and the electric unit do not operate in the battery cooling system for the vehicle according to the exemplary embodiment of the present invention. Referring to FIG. 5, when the motor 125 and the electric unit 126 do not require cooling, the first valve 140 may be configured to close the cooling line 121 connected with the motor 125 and the electric unit 126 and connect the battery cooling line 131. In addition, the second valve 150 may close the second connection line 133 connected with the chiller 135.

Accordingly, the cooling water cooled in the electric unit radiator 113 circulates the battery cooling line 131 by operation of the second water pump 137. Then, the cooling water cooled through the electric unit radiator 122 may be introduced into the battery cooling line 131 and then introduced into the battery module 130 through the turned-off heater 130. Accordingly, the cooled cooling water may cool the battery module 130.

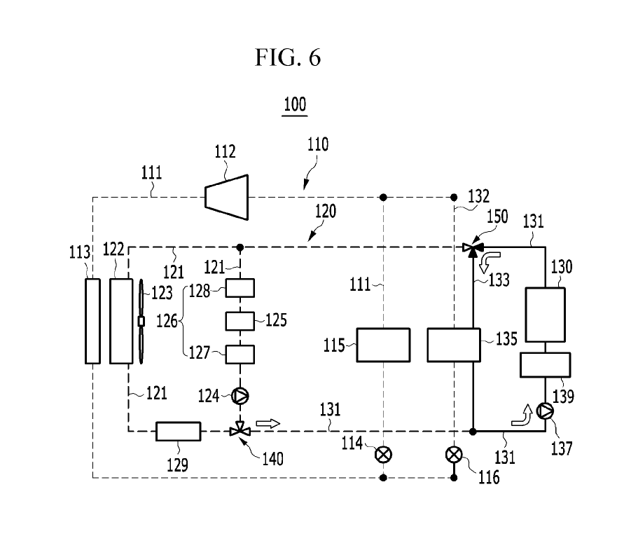

FIG. 6 is an operational view illustrating warming up of the battery when the air conditioning device and the electric unit cooling device do not operate in the battery cooling system for the vehicle according to the exemplary embodiment of the present invention. Referring to FIG. 6, for warming up the battery module 130, the second valve 150 may be configured to close the connection of the cooling line 121 and the battery cooling line 131, and connect the second connection line 133.

Further, the cooling water in the battery cooling line 131 may circulate in the battery cooling line 131 by operation of the second water pump 137. In particular, the heater 139 may be configured to operate to heat the cooling water circulating the battery cooling line 131 to introduce the heated cooling water into the battery module 130. Accordingly, the battery module 130 may be rapidly warmed up by introduction of the heated cooling water.

Thus, the battery cooling system 100 configured as above according to the exemplary embodiment of the present invention may selectively use a refrigerant and cooling water circulating in the air conditioning device 110 and the electric unit cooling device 120 within the electric vehicle or the hybrid vehicle to warm up or cool down the battery module 130 in a water-cool manner thus simplifying the system, and the battery may be effectively managed thereby increasing a total travel distance of the vehicle.

In addition, the entire system may be simplified to thus reduce manufacturing cost and the weight of the system, and spatial utilization may be improved. Further, the number of valves for inter-working of the air conditioning device 110 and the electric unit cooling device 120 may be reduced to thereby reduce cost, and noise and vibration due to frequent valve opening and closing operations may be reduced to thereby improve riding comfort of the vehicle.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A battery cooling system for a vehicle, comprising:
an air conditioning device including a compressor, a condenser, an evaporator, and a first expansion valve connected via a refrigerant line and configured to circulate a refrigerant to cool the interior of the vehicle;
an electric unit cooling device including an electric unit radiator and a first water pump connected with a cooling line and configured to circulate cooling water to cool a motor and an electric unit;
a battery module connected with the electric unit cooling device via a battery cooling line;
a chiller connected with the refrigerant line of the air conditioning device via a first connection line, connected with the battery cooling line via a second connection line, and configured to adjust a temperature of the cooling water by selectively heat-exchanging the cooling water and the refrigerant introduced thereinto;
a second water pump disposed on the battery cooling line between the battery module and the chiller; and
a heater disposed on the battery cooling line between the second water pump and the battery module.

2. The battery cooling system for the vehicle of claim 1, wherein the first connection line includes a second expansion valve disposed between the condenser and the chiller.

3. The battery cooling system for the vehicle of claim 2, wherein the second expansion valve is configured to operate when a vehicle cooling mode starts or to cool the battery module using the refrigerant, and expands the refrigerant introduced through the first connection line and introduces the expanded refrigerant to the chiller.

4. The battery cooling system for the vehicle of claim 1, wherein the battery cooling line includes:
a first valve connecting the cooling line that connects the motor and the electric unit and the battery cooling line between the electric unit radiator and the heater; and
a second valve connecting the cooling line, the battery cooling line, and the second connection line connected with the chiller between the battery module and the electric unit radiator.

5. The battery cooling system for the vehicle of claim 3, wherein the first valve connects the cooling line connected with the electric unit radiator, the cooling line connected with the motor and the electric unit, and the battery cooling line when cooling the battery module using cooling water.

6. The battery cooling system for the vehicle of claim 5, wherein the second valve is configured to close the second connection line when cooling the battery module using cooling water.

7. The battery cooling system for the vehicle of claim 3, wherein the second valve is configured to close the cooling line and connect the battery cooling line and the second connection line when cooling the battery module using a refrigerant.

8. The battery cooling system for the vehicle of claim 3, wherein the first valve and the second valve are 3-way valves.

9. The battery cooling system for the vehicle of claim 3, wherein a reservoir tank is disposed on the cooling line between the electric unit radiator and the first valve.

10. The battery cooling system for the vehicle of claim 2, wherein the electric unit includes:
an electric power control unit (EPCU) disposed on the cooling line between the motor and the first water pump; and
an on-board charger (OBC) disposed on the cooling line between the motor and the electric unit radiator.

11. The battery cooling system for the vehicle of claim 1, wherein the first water pump and the second water pump are electrical water pumps.

12. The battery cooling system for the vehicle of claim 1, wherein, when warming up the battery module, the heater is turned on to heat cooling water circulating the battery cooling line and introduce the heated cooling water to the battery module.
